(19) United States
(12) Patent Application Publication
(10) Pub. No.: US 2009/0268553 A1
(43) Pub. Date: Oct. 29, 2009

(54) ULTRASONIC SENSOR SYSTEM AND METHOD FOR SENSING DISTANCE

(75) Inventors: Donald R. Ecker, Cleveland, OH (US); Tareq Ziyad Murad, Beachwood, OH (US); Hermann Wieth, Chagrin Falls, OH (US)

Correspondence Address: Fay Sharpe LLP, 1228 Euclid Avenue, 5th Floor, The Halle Building, Cleveland, OH, 44115, US

(73) Assignee: Pepperl+Fuchs, Inc., Twinsburg, OH (US)

(21) Appl. No.: 12/140,363

(22) Filed: Jun. 17, 2008

Related U.S. Application Data
(60) Provisional application No. 61/047,534, filed on Apr. 24, 2008.

(51) Int. Cl. G01S 3/80

(52) U.S. Cl. 367/119

(57) ABSTRACT

Methods and ultrasonic sensor systems are presented for sensing distance in which an acoustic output signal is directed toward a target and acoustic input signals are received from the direction of the target, and the received signal is compared with a selected one of a plurality of different receiver threshold curves to identify the acoustic wave travel time to the target and back while differentiating between the target and acoustic waves reflected more than once and waves reflecting off obstructions between the sensor and the target, where the user selectable receiver threshold curves are tailored for different target and/or obstruction conditions.

### REFERENCE TO RELATED APPLICATION

This application claims priority to and the benefit of U.S. Provisional Patent Application Ser. No. 61/047,534, which was filed Apr. 24, 2008, entitled ULTRASONIC SENSOR SYSTEM AND METHOD FOR SENSING DISTANCE, the entirety of which is hereby incorporated by reference.

### FIELD OF THE INVENTION

The present disclosure relates generally to distance sensing and more particularly to ultrasonic sensors methods for sensing distance.

### BACKGROUND OF THE INVENTION

Distance measurements are useful in controlling a variety of automated operations in agriculture, manufacturing, etc., where the distance from a known location to a target object is of interest. For example, in the operation of large combines accurate knowledge of the distance between cutting apparatus and the underlying ground surface is needed to ensure uniformity in the height of cut crops and to avoid the cutting blades striking the ground, particularly in crop fields having varying topography. Previous ground distance sensors for such applications generate ultrasonic acoustic signals which bounce or are reflected off the ground, and the time is measured between the signal generation and receipt of an acoustic echo signal. Based on the speed of the acoustic sound waves, the distance can be determined from the reflection time measurement. One such system is described in U.S. Pat. No. 5,060,205 to James Phelan, the entirety of which is hereby incorporated by reference as background information. Although ultrasonic sensing techniques offer advantages in ground distance sensing applications, simple time measurements based on received acoustic signals are made difficult by variations in the absorptive nature of the soil, double-bounce situations in which acoustic signals bounce more than once between the sensor/machine and the ground, as well as early receipt of acoustic signals that reflect off crops, trash, weeds, stones, and other obstructions between the sensor and the ground surface. Conventional ultrasonic sensors have proven largely ineffective and unreliable for use in control systems for precisely positioning cutting apparatus at a known height above the ground. Moreover, as tighter control of cutting implement-to-ground distances are demanded by modern agricultural farming methods, improved distance sensing techniques and ultrasonic distance sensing systems are needed to provide accurate ground distance measurements in the presence of varying soil, obstruction, and other environmental factors.

### SUMMARY OF INVENTION

Various aspects of the present disclosure are now summarized to facilitate a basic understanding of the disclosure, wherein this summary is not an extensive overview of the disclosure, and is intended neither to identify certain elements of the disclosure, nor to delineate the scope thereof. Instead, the primary purpose of this summary is to present some concepts of the disclosure in a simplified form prior to the more detailed description that is presented hereinafter. The disclosure relates to methods and ultrasonic distance sensor systems for ground distance measurements or other applications in which an acoustic output signal is directed toward a target and acoustic input signals are received from the direction of the target, and the received signal is compared with a selected one of a plurality of different receiver threshold curves to identify the acoustic wave travel time to the target and back while differentiating between the target and acoustic waves reflected more than once and waves reflecting off obstructions between the sensor and the target, where the user selectable receiver threshold curves are tailored for different target and/or obstruction conditions. The disclosure thus provides a novel solution for ground distance sensing applications for farming equipment used for harvesting a variety of crops at different times of the year, as well as a solution of general applicability to ultrasonic distance measurement applications in industry and elsewhere.

In accordance with one or more exemplary aspects of the present disclosure, an ultrasonic sensor system is provided for sensing the distance between the system and a target. The sensor system includes an ultrasonic transceiver system that directs an acoustic output signal toward the target surface, and generates a received signal based on an acoustic input signal received from the target direction. The sensor system further provides a processing system that initiates the acoustic output signal and generates a measurement output signal for use by a control system or other external device when the received signal amplitude exceeds a receiver threshold curve.

The system, moreover, includes a memory that stores two or more receiver threshold curves, which in certain embodiments are tailored for different target conditions such as soil type, wet or dry ground, etc., and for different obstruction conditions such as crop type, crop height, etc. for example. In various embodiments, moreover, one or more of the receiver threshold curves have a generally negative slope to accommodate differentiation between signals reflecting for the first time off the actual ground surface and signals related to obstructions and double-bounce phenomena. In addition, the curves may be non-linear for further tailoring to a given application. The processing system in this regard includes a curve selection component that operates to select one of the receiver threshold curves based on a select input value. In various exemplary implementations detailed hereinafter, the select input value is provided by an operator via a control system on a farming machine, thus allowing the operator/control system to adapt the ground distance measurement capabilities of the sensor to specific conditions of the current application, and to reconfigure the sensor system as conditions change.

In certain embodiments, moreover, the processing system may provide a communications interface by which one or more receiver threshold curves may be downloaded from an external device and/or with which an external device may modify one or more receiver threshold curves stored in the system. In this manner, the sensor system can be preloaded with a selection of different threshold curves targeted toward certain applications, and a user can create and save further curves tailored to the user's specific operating conditions, and the user can modify any of the curves stored in the system at any time. Thus, the disclosure contemplates universally applicable sensor systems that can be configured to accommodate an unlimited number of applications to facilitate precise distance measurement.

The transceiver system may be of any suitable form for generating and receiving acoustic signals for target distance measurement. In one possible embodiment, a single ultrasonic transceiver is employed to direct an acoustic output signal from a transmit face toward the surface of the target and also to generate the received signal based on a received acoustic input signal.

In another possible embodiment, the transceiver system includes an ultrasonic transmitter which directs the acoustic output signal from a transmit face in a first direction toward a surface of the target in response to a first signal, and an ultrasonic receiver with a sensing face that operates to receive acoustic input signals reflected off the target and any intervening obstructions and to generate the received signal based on the acoustic input signals received from the first direction. In certain implementations of this embodiment, moreover, the transmit face of the transmitter is generally perpendicular to the first direction so as to generally face the target directly, while the sensing face of the receiver faces a second direction, with the first and second directions being offset from one another by a sensing angle. This angular offset facilitates reduction in the level of acoustic signals attributable to double bounce and obstructions while allowing proper receipt of the primary ground signal. In certain embodiments of this aspect of the disclosure, the sensing angle is about 5 degrees or more and about 45 degrees or less, more preferably about 5 degrees or more and about 15 degrees or less to provide a mechanical improvement on the sensing capabilities of the system. Moreover, the ultrasonic receiver may advantageously be spaced slightly farther from the target than is the transmitter, for example, with the spacing difference in the range of about 0.125 inches to about 1.00 inches.

In addition to mechanical advantages, certain implementations of the sensor system may include a logarithmic amplifier that amplifies the received signal from the transceiver system in a non-linear fashion to provide an amplified signal to the processing system for comparison with the receiver threshold curve. This feature may help to increase the amplitude of low-level received signals to improve the sensing margin to aid in differentiating between the primary ground reflection and those due to obstructions and/or double bounce reflections.

In addition to providing a measurement output signal for use by a control system or other external device, the processing system may itself compute a distance measurement value based on the time between the start of the acoustic output signal and the time when the received signal is greater than the receiver threshold curve. In this aspect of the disclosure, moreover, the system may provide a distance measurement output indicative of the distance measurement value, for example, an analog signal or digital value representing the measured sensor-to-target distance.

In another exemplary aspect of the disclosure, the system further includes a thermal sensor which senses the ambient temperature and provides a temperature signal indicative of the ambient temperature. The processing system in these embodiments may include a temperature compensation component that selectively adjusts the timing of one or both of the acoustic output signal and the measurement output signal based on the temperature signal. In this manner, the distance value derived from the time difference between these signals will be temperature compensated to account for temperature related changes in the transmission speed of acoustic waves. Where the system is adapted to compute a distance value, moreover, the temperature compensation component selectively adjusts the distance measurement value based on the temperature signal, and provides the distance measurement output indicative of the adjusted distance measurement value.

Further aspects of the disclosure relate to a method for measuring distance in an ultrasonic sensor system. The method includes the steps of receiving a select input value identifying one of a plurality of receiver threshold curves and selecting an identified one of the curves according to the select input value. An acoustic output signal is directed in a first direction toward a target and an acoustic input signal is received from the first direction to generate a received signal. The method further includes comparing the received signal to the selected receiver threshold curve and generating a measurement output signal when the received signal is greater than the selected curve. In certain implementations, the method may also include receiving one or more receiver threshold curves from an external device, and/or allowing an external device to modify one or more receiver threshold curves stored in the system. Other embodiments of the method include sensing an ambient temperature and adjusting the timing of at least one of the acoustic output signal and the measurement output signal based on the temperature signal. In addition, the method may provide for computing a distance measurement value based on the time between the start of the acoustic output signal and the time when the received signal is greater than the receiver threshold curve, optionally adjusting the distance measurement value based on the temperature signal, and providing a distance measurement output indicative of the adjusted distance measurement value. The method may further include selectively driving an ultrasonic receiver of the sensor system to clean the receiver.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description of the disclosure when considered in conjunction with the drawings, in which:

FIG. 1A is a sectional side elevation view illustrating a first embodiment of an ultrasonic sensor system with spaced ultrasonic transmitter and receiver oriented at different angles as well as a processing system interfacing with an external control system for selection among two or more stored receiver threshold curves in accordance with various aspects of the disclosure;

FIG. 1B is a sectional side elevation view illustrating another exemplary embodiment of an ultrasonic sensor system using a single ultrasonic transceiver for sending and receiving acoustic signals in accordance with the disclosure;

FIG. 2 is a system level diagram illustrating further details of the processing system of the embodiments of FIGS. 1A and 1B;

FIG. 3 is a partial side elevation view illustrating an ultrasonic sensor system mounted on a portion of an agricultural machine traveling over a ground surface having crops and other obstructions to measure the distance from the machine to the ground;

FIG. 4 is a graph illustrating exemplary received signals from acoustic waves sensed by an ultrasonic receiver of the sensor system showing an initial pulse reflecting off a first target surface with relatively low absorption characteristics at three exemplary distances X, 2X, and 3X from the sensor;

FIG. 5 is a graph illustrating the exemplary received pulse signals of FIG. 4, along with two secondary (double-bounce) signal pulses of successively diminishing amplitude corresponding to multiple reflections off the target at distance X, and an exemplary single reflection off an intervening obstruction between the sensor and the ground surface, showing an exemplary first receiver threshold curve with a negative slope over time tailored for the low absorption first target surface and associated obstruction conditions that is stored in the sensor system for comparing received signals to differentiate single-reflection signals from the ground surface from signals related to double-bounces and obstructions in accordance with the disclosure;

FIG. 6 is a graph illustrating exemplary received signals from acoustic waves sensed by the ultrasonic receiver of the sensor system showing an initial pulse reflecting off a second target surface with relatively high absorption characteristics at three distances X, 2X, and 3X from the sensor, along with two secondary signal pulses corresponding to the target at distance X, an exemplary single reflection off an obstruction overlying the ground, the first receiver threshold curve from FIG. 5, and an exemplary second receiver threshold curve tailored for the second target surface and associated obstruction conditions;

FIG. 7 is a graph illustrating four exemplary receiver threshold curves tailored for various different target surface and obstruction conditions that may be stored in the sensor system and selected by a user or by an external control system in accordance with the disclosure;

FIG. 8 is a graph illustrating another possible set of four receiver threshold curves having non-linear shapes adapted for different target surface and obstruction conditions in accordance with the disclosure;

FIG. 9 is a graph illustrating operation of an exemplary logarithmic amplifier to amplify received signals in accordance with further aspects of the disclosure; and

FIG. 10 is a flow diagram illustrating an exemplary distance sensing method in accordance with various aspects of the present disclosure.

### DETAILED DESCRIPTION OF THE INVENTION

Referring now to the figures, several embodiments or implementations of the present disclosure are hereinafter described in conjunction with the drawings, wherein like reference numerals are used to refer to like elements throughout, and wherein the various features and plots are not necessarily drawn to scale. The disclosure relates to the use of acoustic signaling for measuring the distance to a target, and is described hereinafter in the context of exemplary systems adapted for use in sensing the distance from a machine or other structure to the surface of the ground, although the various aspects of the disclosure find utility in any distance sensing application and the disclosure is not limited to the specific embodiments illustrated and described herein.

In the illustrated embodiments, ultrasonic waves are employed to measure the distance to a ground surface, and the measured ground distance is used to control equipment used in tillage, seeding, above ground harvesting, etc. In these conditions, crops, plants, weeds, trash, and other obstructions between the sensor system and the ground can cause reflections and may scatter, absorb, and otherwise disturb ultrasound acoustic waves used in the distance measurement. In order to produce a reflection from the ground surface of interest of large enough magnitude to facilitate reliable detection, the disclosed sensor system preferably employs relatively high levels of generated ultrasound output signals. Along with the use of increased ultrasound power levels, signal reflection from plants and other obstructions increases, and at closer distances, secondary or multiple re-echoes from ground increase as well. The disclosed systems and methods enhance the reliability of ultrasonic distance measurement techniques to facilitate identification and differentiation between the primary echo signal from the target surface of interest and signals related to obstructions and double-bounce signals.

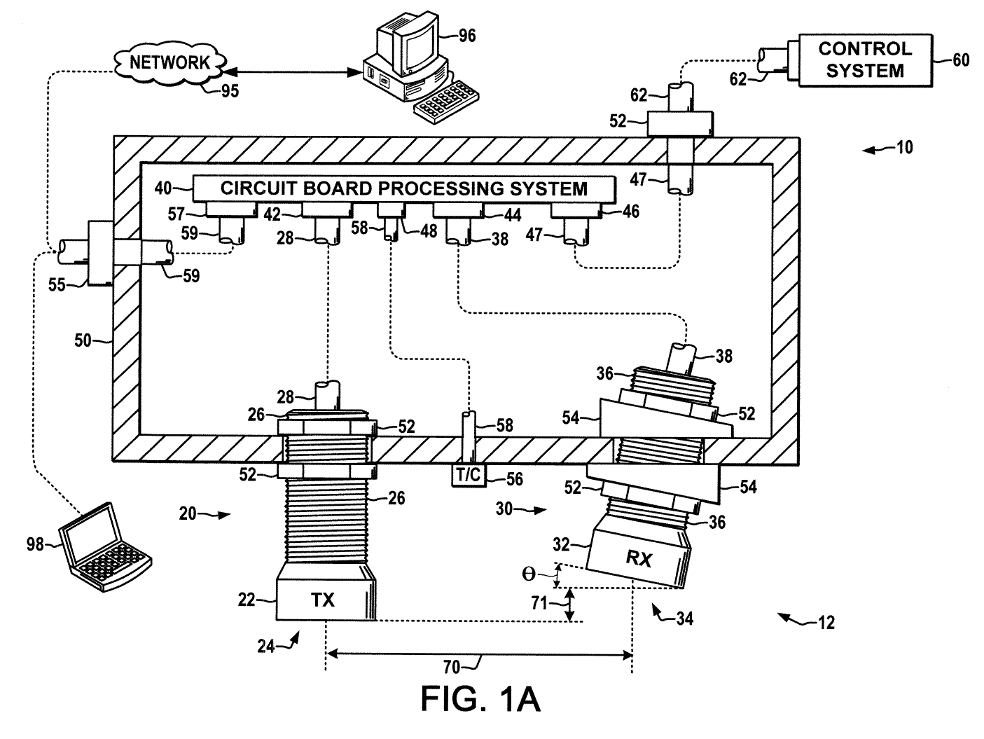

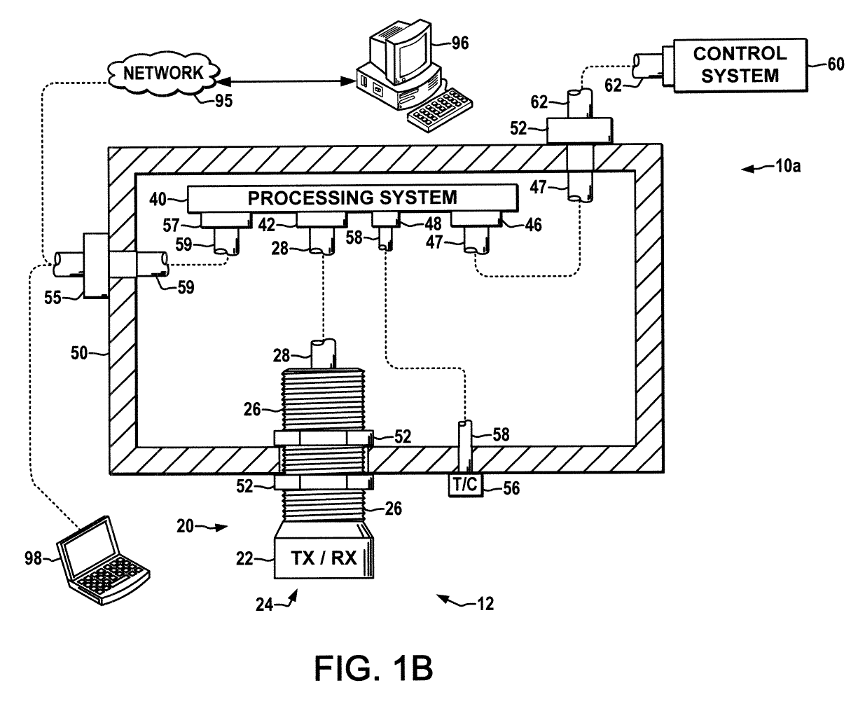

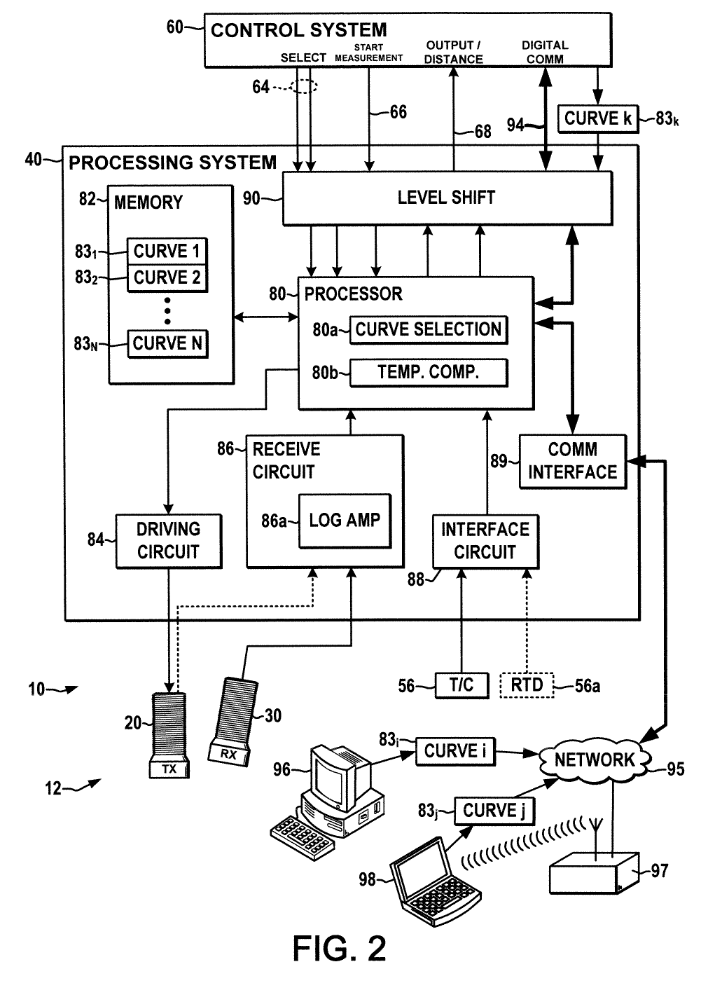

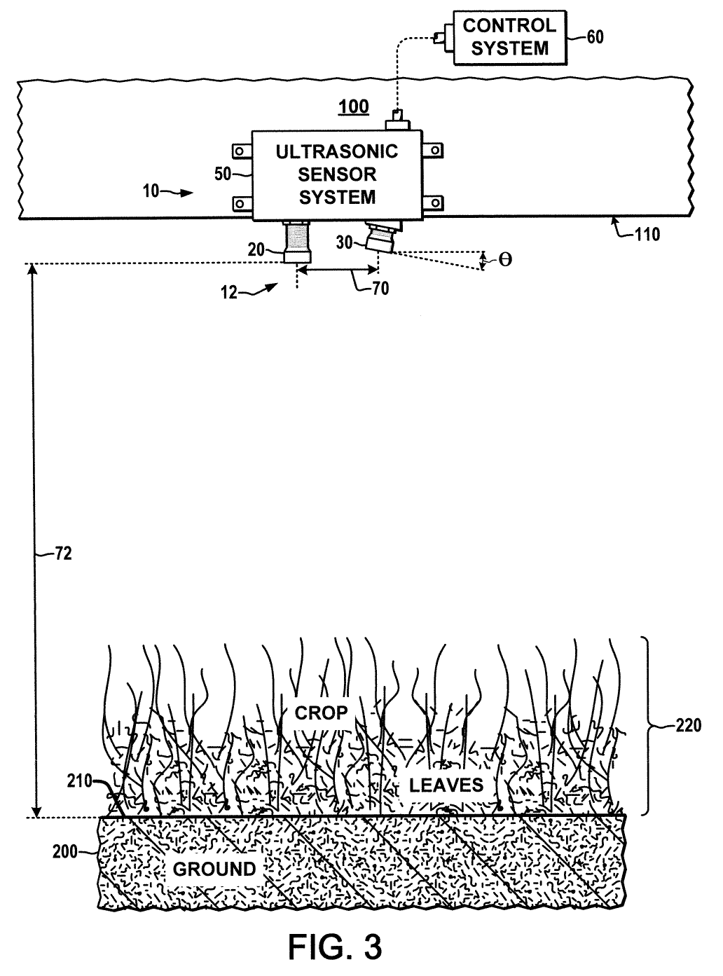

Referring initially to FIGS. 1A, 1B, 1, and 3, FIG. 1A illustrates an exemplary ultrasonic sensor system 10 with a housing 50 suitable for mounting on a farming machine such as a tractor or combine for sensing a distance between the system 10 and an underlying target such as the upper surface 210 of the 200 shown in FIG. 3. The system 10 includes an ultrasonic transceiver system 12 that directs acoustic output signals generally downward in FIG. 1A toward the target and receives reflected acoustic signals from the target and from intervening obstructions such as from the ground surface 210 and the crop or leaf type obstructions 220 in FIG. 3. The transceiver system 12 generates a received signal based on such acoustic input signals received from the target direction. The transceiver system 12 is operatively coupled with a processing system 40, such as a microprocessor-based circuit board in one embodiment. The processing system initiates the generation of the acoustic output signal and generates a measurement output signal 68 (FIG. 2) when the received signal from the transceiver 12 exceeds a receiver threshold curve 83 as illustrated and described in greater detail below.

The sensor system 10 in one implementation is operated by an external control system 60 (FIG. 2) which provides select input signals or values 64 and operates as a sensor with the external control system 60 providing a START MEASUREMENT signal 66 to the processing system 40, the system 40 initiating the acoustic output signal via the transceiver 12 based on receipt of the START MEASUREMENT signal 66. Upon receiving an input acoustic signal (including reflections from the target 200 and obstructions 220 in FIG. 3), the transceiver system 12 provides a received signal which is compared in the processing system 40 with a selected one of two or more curves 83 stored therein (FIG. 2), and provides an OUTPUT/DISTANCE signal 68 to the control system 60 based on this comparison. In this mode of operation, the control system then computes the distance to the target based on the time between the START MEASUREMENT signal 66 and the received OUTPUT / DISTANCE signal 68 using a known speed of sound in the computation. In another operating mode, the sensor system 10 may itself compute the sensed distance and provide a distance measurement output 68 to the control system 60, such as an analog output signal, a digital value, etc. In the illustrated embodiments, the sensor system 10 may be operated in either mode or in both modes simultaneously, although not a strict requirement of the present disclosure.

As best shown in FIGS. 1A and 2, the transceiver system 12 in one embodiment includes an ultrasonic transmitter 20 which is operated by a signal from driving circuit 84 of the processing system 40 to direct an acoustic output signal from a transmit face 24 in a generally downward first direction. The exemplary driving circuit 84 includes circuitry that drives the ultrasonic transmitter 20 at or near its resonant frequency to generate a burst of ultrasound in the form of an acoustic output signal directed downward toward the target of interest. The exemplary processing system 40 can initiate the acoustic output itself or can do this in response to the START MEASUREMENT signal 66. As noted below, the system 10 may include temperature compensation components and may selectively provide a delay between receipt of the START MEASUREMENT signal 66 and the generation of the acoustic output signal according to a sensed ambient temperature. The transceiver in this embodiment also includes a separate ultrasonic receiver 30 with a sensing face 34 that receives acoustic input signals reflected off the target 200 and any intervening obstructions 220 and generates a received signal based on the acoustic input signals received from the target direction.

In one implementation shown in FIG. 1A, the sensor system 10 provides a housing 50, such as a plastic or metal enclosure, with the transmitter 20 including a threaded cylindrical body 26 and a transmit end 22 with a sensing face 24 and being mounted in an aperture of a lower wall using nuts 52 such that the surface of the sensing face 24 is generally horizontal and perpendicular to the downward direction, such as within about 1 or 2 degrees of facing straight downward. The transmitter is operative to generate acoustic signals, and may be of any suitable type preferably suitable for outdoor operation, such as including a piezo actuator to displace a flexible face structure 24 at an ultrasonic frequency of about 40 kHz or more in one example. One suitable transmitter 20 is a Pepper1+Fuchs ultrasonic Transducer model number UW85-K30-M30-B operated at about 85 KHz.

The exemplary receiver 30 may be similarly constructed or may be a different design, wherein the illustrated receiver 30 includes a threaded body 36 and a sensing end 32. In a preferred embodiment, the receiver is mounted through an aperture in the housing 50 using beveled structures 54 and nuts 52 as shown in FIG. 1A. This mounting advantageously orients the sensing face 34 toward a second direction offset from that of the transmitter 20 by a sensing angle θ of about 5 degrees or more and about 45 degrees or less, more preferably about 5 to 15 degrees. In the illustrated embodiment, moreover, the receiver 30 is angled in the general direction toward the transmitter 20 by the amount θ, although not a strict requirement of the disclosure. The transmitter 20 and the receiver 30 are mounted to the housing such that the transmit and sensing faces 24 and 34 are spaced by a distance 70 of about 2 to 5 inches in one example. Moreover, as shown in FIG. 1A, the lower end of the receiver 30 in one preferred implementation is situated a distance 71 higher than the lower end of the transmitter 20, so as to reduce the chance of the receiver 30 detecting acoustic signals directly from the transmitter 20 and/or to reduce the level of any such received signal that travels directly from the transmitter 20 to the receiver sensing face 34. In one embodiment, this vertical spacing distance 71 is about 0.125 inches or more and about 1.00 inches or less to mitigate false detection of signals that are not reflected off the target 200.

Referring also to FIG. 3, the transmitter 20 and receiver 30, moreover, are preferably rated for measurement at distances of about 4 times the distance to be sensed in use. For example, in farming equipment ground distance sensing applications requiring a sensing distance range of about 1 meter, the transmitter 20 and the receiver 30 are selected to have a rating of about 4 meters. As shown in FIG. 3, the sensor housing 50 may be mounted, for example, to a divider structure 100 of a combine in such a way as to allow the transmitter 20 and receiver 30 to face generally downward toward the surface 210 of the ground target 200 over which the combine is travelling during a crop cutting operation. This configuration allows measurement of the distance 72 between the transmitter and receiver locations and the ground surface 220. Knowing this distance 72 and the vertical distance between the lower edges of the cutting implements (not shown) and the transmitter 20 and receiver 30, the distance measurement can be used in a control scheme to maintain the cutting devices a desired setpoint distance above the ground surface 210 in order to achieve a desired cutting height for the crop in a given field. In this regard, a lower surface 110 of the divider structure 100 and other lower surfaces of the combine, the sensor housing 50, etc., may provide surfaces from which received acoustic signals will be directed downward more than once, leading to receipt at the ultrasonic receiver of acoustic signals known as ‘double-bounce’ signals, where the stored receiver threshold curves can be adapted to facilitate differentiation between these signals and the signals of interest in determining the distance 72 to the actual ground surface 210.

The processing system 40 in one embodiment can be one or more printed circuit boards as shown in FIG. 1A, having various connectors 42, 44, 46, 48, and 57 for connecting cables for carrying signals to and from other system components. In the illustrated example, the transmitter 20 has a cable 28 coupled to PCB connector 42 for receiving power and signaling from the processing board 40, and the ultrasonic receiver 30 similarly connects to the processing board 40 via a cable 38 and connector 44. The processing system 40 includes a connector 46 for connecting electrical power and signaling with the external control system device 60 via internal cable 47, feed-thru connector 52, and external cable 62. The board 40 may also provide a digital communications connection 57 with a cable 59 and feed-thru connection 55 to provide connectivity to a computing device (e.g., portable computer, PDA, etc.) 98 or network 95 such that various receiver threshold curves 83 can be modified or sent by external devices 96, 98 via the connection 55 or by the control system device 60 via the connection 52.

Referring now to FIG. 1B, another exemplary embodiment of an ultrasonic sensor system 10a is shown, which uses a single ultrasonic transceiver 20 for sending and receiving acoustic signals in accordance with the disclosure. In this embodiment, the transceiver 20 is again preferably of the piezo type described above, and preferably faces directly downward (e.g., within about 1 or 2 degrees), and is mounted to the underside of the enclosure 50 using nuts 52. In this case, the processing system 40 actuates driving circuitry (e.g., circuit 84 in FIG. 2) to initially initiate an acoustic output signal from the transceiver 20 toward the target 200, and then uses receiver circuitry connected to the transceiver 20 to receive signals indicating receipt of acoustic reflections from the target 200, obstructions 220, etc. In the embodiment of FIG. 1B, the transceiver 20 generates a burst of ultrasound as an acoustic output signal and switches into a receiver mode, where the time required to recover from transmitting sound until the transceiver 20 can detect a return (input) signal leads to a minimum operating distance with shorter distances being undetectable (e.g., “deadband”). The embodiment of FIG. 1A, on the other hand, advantageously employs a separate transmitter 20 and receiver 30 to eliminate such deadband issues to facilitate target distance sensing at a much closer distance than a single transceiver design. Moreover, the dual device implementation shown in FIG. 1A advantageously allows positioning of the receiver 30 at a slight angle θ to the transmitter 20 as shown, by which secondary received signals decay much faster than if both devices 20 and 30 were pointed straight down or if only one a single transceiver 20 is used as in FIG. 1B.

As depicted in FIGS. 1A, 1B, and 2, moreover, the sensor system 10, 10a may optionally include a temperature sensor 56, such as a thermocouple (T/C 56), RTD 56a (FIG. 2) or other sensor that senses an ambient temperature at or proximate the sensor system 50 and that provides a temperature signal via cable 58 and board connector 48 indicative of the ambient temperature. Using this, the processing system 40 can optionally temperature compensate the OUTPUT/DISTANCE signal 68 by either delaying the generation of the acoustic output from the transmitter 20 and/or by delaying the provision of the OUTPUT/DISTANCE signal 68 itself. In another mode of operation, where the processing system 40 performs a distance measurement calculation, the temperature input value provided by the sensor 56 can be employed in the computation to account for changes in the speed of sound as a function of temperature.

Referring now to FIG. 2, the exemplary processing system 40 includes a memory 82 that stores two or more receiver threshold curves 83₁ through 83_{N}, where N is an integer greater than 1. The system 40 also includes a curve selection component 80a which is operative according to received select signals or values 64 to select one of the receiver threshold curves 83 for use in a given situation. Alternatively, the selection component 80a can be operated via messaging through a communications interface 89 (e.g., connections 55, 57, and 59 in FIGS. 1A and 1B) for curve selection by an external device, whether the control system 60, computers 96, and/or 98, etc. The exemplary system 40 also includes a processor 80, which can be a microprocessor, microcontroller, microcomputer, DSP, or any other form of programmable logic implemented as hardware, software, firmware, logic, or combinations thereof, and which may be implemented in a unitary device or system, or which can be implemented in distributed fashion including multiple devices or systems performing various operations in coordinated fashion. The processor 80 is adapted to monitor input signals and messaging from the control system 60 and/or from other external devices 96, 98, and also drives all outputs to the external devices and the transceiver system 12 and associated circuitry, including enabling the driving circuit 84 to generate bursts of ultrasound as acoustic output signals, receiving analog or digital signals/values from the receive circuit 86. The processor 80 also compares the received input to a selected one of the stored threshold curves 83 in the memory 82.

In implementations using the optional thermal sensor 56 or those having temperature values provided to the processing system 40 from external sources, the processor 80 may include a temperature compensation component 80b, such as software/firmware components, logic, etc., which operates to selectively adjust the timing of one or both of the initial provision of the acoustic output signal and the generation of the measurement output signal 68 based on the temperature reading from the sensor 56. Moreover, in another mode of operation, the processing system 40 computes a distance measurement value based on the time between the start of the acoustic output signal and the time when the received signal level exceeds the selected receiver threshold curve 83. In this case, if a temperature sensor 56 or other source of a temperature value is employed; the temperature compensation component 80b selectively adjusts the distance measurement value based on the temperature signal or value, such that the system 10 provides a distance measurement output 68 indicative of the adjusted distance measurement value. In this manner, the distance measurement computed by either the system 10 or the control system 60 or other external device is compensated according to the variation in the speed of sound as a function of temperature.

Referring also to FIG. 9, in another aspect of the disclosure, the sensor system 10 further includes a logarithmic amplifier 86a (FIG. 2) coupled to receive the input signal from the receiver 30. The log amp 86a may form part of a receive circuit 86 that may further provide filtering and other components to selectively reject or diminish all frequencies except a small band including the resonant frequency of the transmitter 20. The receive circuit 84 may further include components adapted to convert received ultrasound levels from the receiver 30 into an analog signal (or a digital value) that is proportional to, or otherwise indicative of, the received ultrasound power level, and the optional log amp 86a may amplify this signal non-linearly, such as logarithmically to provide a signal to the processor 80 for comparison with the stored threshold curves 83. In operation, the amplifier 86a amplifies the received signal from the transceiver system 12 non-linearly as shown in the graph 900 of FIG. 9. In this implementation, the amplitude of low-level received signals is increased to provide an amplified signal to the processing system 40 for comparison with the selected receiver threshold curve 83, wherein the curve 901 has higher output gain for low input values than for higher input values. The output/input gain may be any non-linear relationship within the scope of the disclosure, for example, a logarithmic relationship. This feature facilitates improved sense margin to more easily differentiate between the primary ground reflection and those due to obstructions and/or double bounce reflections.

As shown in FIG. 2, the processing system 40 may include other circuitry, for instance, such as level shift circuitry 90 for providing any needed signal level adjustment to interface the control system 60 with the processor 80 for exchange of one or more select signals 64, START MEASUREMENT signal 66, OUTPUT/DISTANCE signal 68 and for digital information exchange via a parallel or serial data path 94. The circuitry 90 may include, for example, amplifiers, isolation circuits, comparators, analog-to-digital (A/D) and/or digital-to-analog (D/A) converters, etc., and the processor 80 may include integral A/D and/or D/A converters, multiplexers, and other interface circuitry. The level shift circuit 90 in one possible implementation operates to accept 24 volt signal levels from the control system 60 and to translate these to low voltage levels for use by the processor 80, and also translates low voltage outputs from the processor 80 24 volt level signals for input to the control system 60.

In addition, the processing system 40 may include interface circuitry 88 for interfacing an RTD, thermocouple, or other temperature sensing device 56 with the processor 60, such as amplifiers, comparators, discrete circuit components, A/D converters, etc., whereby the processing system 40 can obtain a sensed temperature signal or value for temperature compensation as described above. The digital data path 94, moreover, may employ signals and/or messages for exchanging commands and events corresponding to any of the above described signals, including without limitation the START MEASUREMENT signal, the OUTPUT/DISTANCE signal, etc., and may further provide for downloading or modification of curves 83. Alternatively or in combination, the processing system 40 may provide a communications interface 89 adapted to operatively interconnect the processor 80 with a computing device 96, 98, or a network 95 for a variety of data exchange functions. In the illustrated embodiment, for instance, the interface 89 allows the processor 80 to receive one or more receiver threshold curves 83 from an external device 60, 96, 98 directly or via the network 95, and also allows the external device 60, 96, 98 to modify one or more receiver threshold curves 83 stored in the system memory 82.

As shown in FIG. 2, the processing system 40 may be operatively coupled with a network 95 via the communications interface 89, where the network 95 may be wired or wireless, or combinations thereof, through which communications can be established between the processor 80 and one or more external communications devices. 96, 98, one or more of which may communicate with the network 95 via a wireless interface 97. In other possible embodiments, the communications interface 89 may allow direct connection of the external computers 96, 98, or the control system 60, and the processing system 40 may include integral wireless interface components. By one or more of these information exchange mechanisms, the processing system 40 can receive threshold curves from an external device, such as the control system downloading a curve 83ₖ via the digital communications path 94 and/or the desktop computer 96 or laptop computer 98 downloading a receiver threshold curve 83ᵢ or 83ⱼ via the network 95 and the communications interface 89. In addition, the processing system 40 in certain embodiments is adapted to allow these external devices 60, 96, and/or 98 to upload one or more of the stored curves 83 from the memory 92 and/or to modify one or more of the curves 83, to thereby adjust the sensor capabilities for a given application.

Any form of selection may be implemented by which an external device can select from the receive threshold curves 83₁-83_{N} stored in the memory 82. In the embodiment of FIG. 2, the control system 60 provides two or more SELECT signals 64 which are binary coded such that the set of signals 64 sent by the controller 60 uniquely indicate one of the stored curves 83. For example, two such signals 64 (e.g., to indicate binary values 00, 01, 10, and 11) can be provided to allow selection from among four curves 83 stored in the memory 82. Alternatively or in combination, the sensor system 10 may be adapted to receive selection command messages from the control system 60 via the digital communications path 94 or from an external device 96, 98 via the communications interface 89 including a select input value 64 by which the curve selection component 80a determines which of the curves 83 to employ for comparison with the received signal from the receive circuit 86. The sensor system 10 may operate in conjunction with a user interface mounted to the combine or other machine, where the machine may include an automated control system 60 as shown herein. In one implementation, the user interface may include four signal lines, such as Select0, Select1, START MEASUREMENT, and OUTPUT/DISTANCE output, where the Select0 and Select1 lines allow an operator or the control system 60 to select 1 of up to 4 different receiver threshold curves 83 to allow working with different ground and plant conditions.

In operation, to measure the distance to the ground or other target surface of interest, the control system 60 or operator generates a pulse on START MEASUREMENT which causes the processor 80 to generate a pulse of ultrasound (acoustic output signal) from the ultrasound transmitter 20 via the driving circuit 84. The acoustic output signal reflects from any surface and an acoustic echo returns to the ultrasound receiver 30 which provides a received input signal to the processor 80. The processor 80 compares the received signal with the selected curve 83 to distinguish between ground echoes of interest, and signals reflected off obstructions and double bounce signals, and generates a signal at the OUTPUT/DISTANCE line when a valid ground echo is detected, and/or may compute a distance measurement and provide that as an output (analog or digital value).

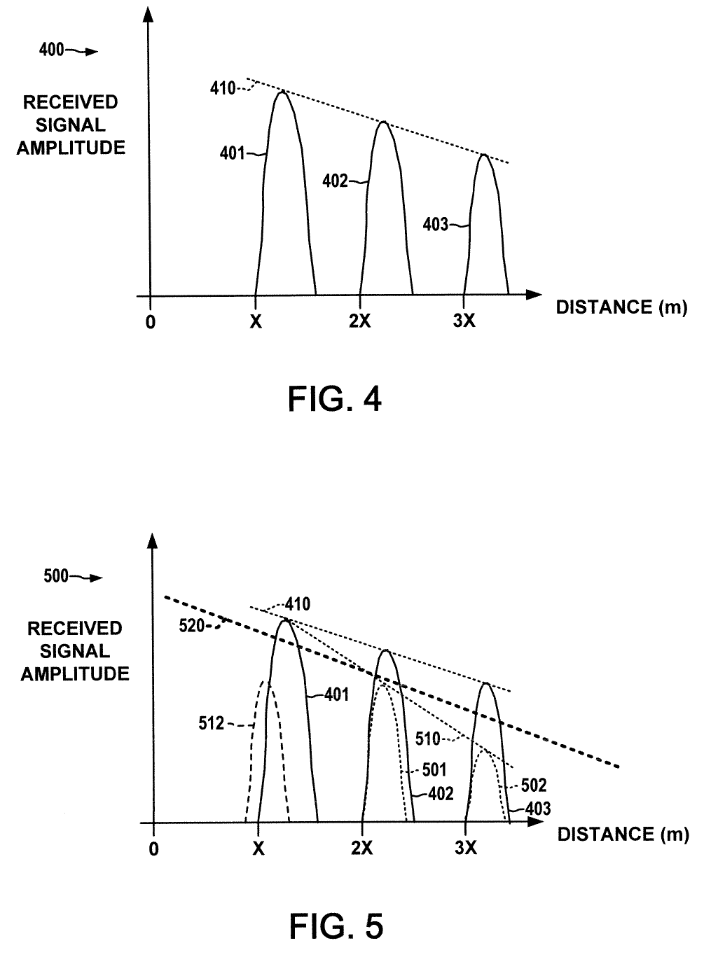

Referring now to FIGS. 4-8, the receiver threshold curves 83 may be any form of storable data that provides a time varying threshold that can be compared to received acoustic input signals obtained from the receiver 30 and the receive circuit 86 for identifying signals reflected from the target surface of interest, typically having a negative slope over time. In two possible implementations, these may take the form of equations with values computed by the processor 80 using coefficients stored in the memory 82, or lookup tables with table values stored in the memory 82 and with the processor 80 performing linear or non-linear interpolation to derive the value of the selected curve 83 at a given point in time relative to the initiation of the START MEASUREMENT signal 66 or the start of the acoustic output signal from the transmitter 20. In the illustrated embodiments, moreover, one or more of the receiver threshold curves 83 are tailored for different target conditions and/or for different obstruction conditions. Furthermore, as shown in FIGS. 4-8, the curves 83 may have a negative slope relative to time and one or more of the curves 83 may be non-linear.

A graph 400 in FIG. 4 shows exemplary received signals from acoustic Waves sensed by an ultrasonic receiver 30 of the sensor system 10. In this example, an initial pulse 401 is received at the receiver 30 after reflecting off a first target surface with relatively low absorption characteristics (e.g., hard ground, concrete, a rock, etc.) at an exemplary distance “X” from the sensor 10. Two other exemplary curves 402 and 403 show received signals from the same target type at distances 2X and 3X, respectively, from the sensor 10. As can be seen in FIG. 4, as the target distance increases, the primary acoustic reflection or echo takes longer to reach the receiver 30, where the graphs in FIGS. 4-8 show relationships having x-axis scales representing both time and distance. In an ideal case, with no obstructions and no double-bounce phenomena as shown in FIG. 4, a comparison of the received signal 401, 402, or 403 with a switching threshold below the peak values along the line 410 could be employed to generate the OUTPUT/DISTANCE signal 68 (FIG. 2), by which the timing between the START MEASUREMENT signal from the control system 60 and the OUTPUT/DISTANCE signal from the sensor system 10 can be used to calculate the distance to the target.

However, as shown in a graph 500 of FIG. 5, the received signal may also include a pulse 512 caused by reflection of the acoustic output signal off an intervening obstruction between the sensor and the ground surface, such as the crop or leaves 220 shown in FIG. 3. Also, double-bounce reflections 501 and 502 may be seen in the received signal having peak values along line 510, due to the acoustic output sound wave reflecting off the ground target surface 210 (or obstructions 220), then reflecting off the sensor 10 or the lower surface 110 of the farming equipment (FIG. 3), and reflecting once more off the target 210 before being received by the receiver 30. In this case, one suitable switching threshold 520 could be employed, which is below the decaying peak level 410 for primary reflections of interest, but which is above the peak of the obstruction signal 512 and also above the peak levels of the double-bounce signals 501 and 502. In this particular set of target and obstruction conditions (e.g., low absorption first target surface and associated obstructions), the exemplary first receiver threshold curve 520 has a negative slope over time and time varying values that are tailored for comparing received signals to differentiate single-reflection signals 401, 402, or 403 associated with the ground surface 210 of interest from signals 501, 502, and/or 512 related to double-bounces and obstructions in accordance with the disclosure.

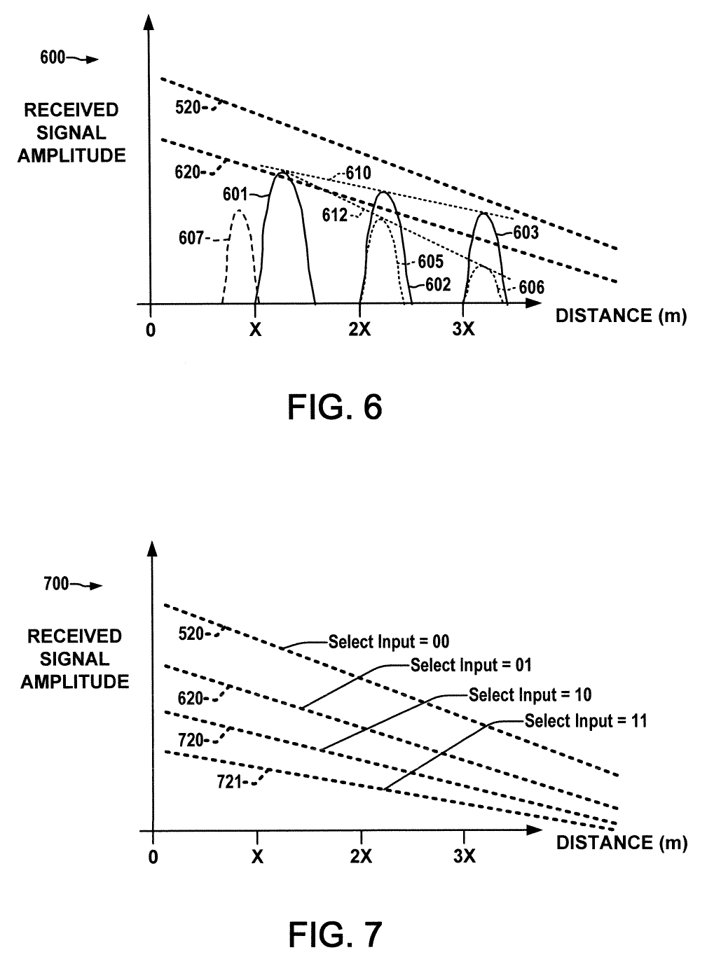

FIG. 6 illustrates a graph 600 showing exemplary received signals from acoustic waves sensed by the ultrasonic receiver 30 in a different situation where the target surface 210 absorbs or disperses significantly more acoustic signal strength. The graph 600 illustrates initial pulses 601, 602, and 603 reflecting off such a second target surface 210 with relatively high absorption characteristics at three exemplary distances X, 2X, and 3X from the sensor, respectively. FIG. 6 also depicts two secondary (double-bounce) signal pulses 605 and 606 corresponding to the target at distance X, and an exemplary single reflection pulse 607 off an obstruction overlying the ground. As shown in FIG. 6, the first receiver threshold curve 520 tailored for the conditions of FIGS. 4 and 5 cannot be reliably used for the conditions of FIG. 6. Thus, for this second set of target and obstruction conditions, an exemplary second receiver threshold curve 620 can be established which is tailored for the second target surface and associated obstruction conditions.

Thus, the inventors have appreciated that ground conditions and different crops, plants, weeds, trash, or other obstruction circumstances can affect the operation of conventional sensors that employ only a single threshold curve or value. Accordingly, the current disclosure contemplates the generation and storage of multiple receiver threshold curves, and selectable employment of specific curves tailored for specific conditions, whereby the described sensor systems 10, 10a present a significant improvement in ultrasonic distance sensing. In one possible situation, different receiver threshold curves 83 can be obtained empirically for different ground and crop conditions, and can be pre-stored in the memory 82 of the sensor system 10, with the user or control system 60 or other external device providing select signals 64 and/or selection commands or messages to the sensor 10 to choose an appropriate curve 83 for a given application. In this regard, the curves 83 may be adapted for different weather conditions, soil wetness or dryness, soil type or consistency, different crop types, or other variables or combinations thereof. Thus, for instance, the control system 60 or an operator may detect or determine that the ground in a wheat field of interest is wet and loosely packed, and that the crop is at a certain height, and select a threshold curve 83 targeted to those conditions, whereas a different curve 83 may be selected for the same field if the ground is dry. It has thus been discovered that generating curves 83 that follow the general characteristics of the primary echo response while remaining above reflections from plants and other obstructions, useful curves 83 can be generated for almost any application of interest.

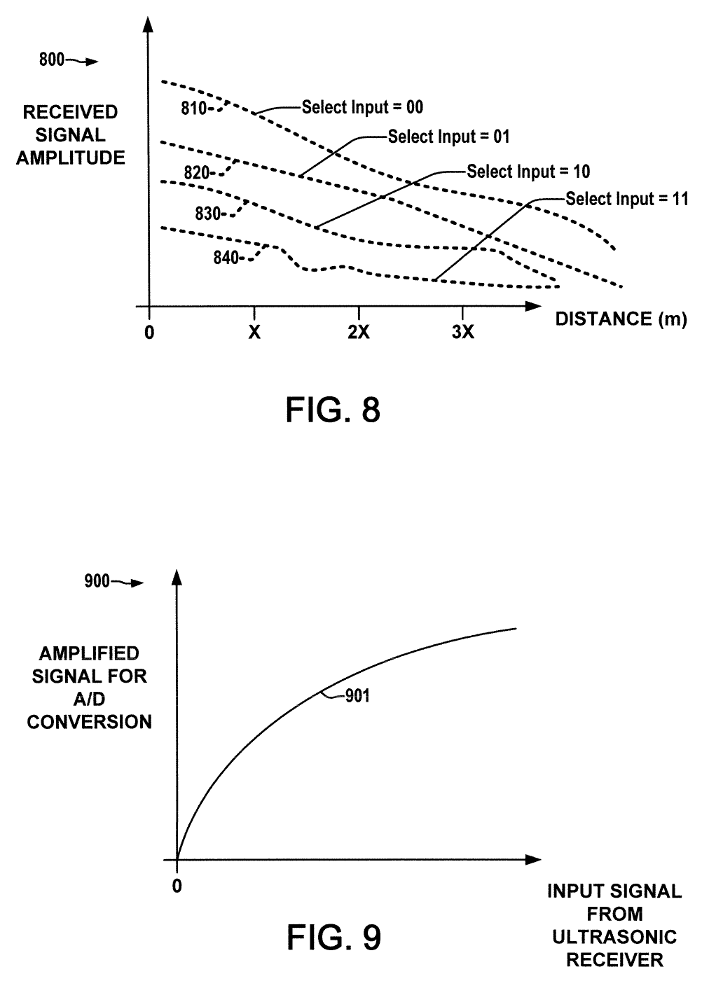

FIG. 7 shows is a graph 700 illustrating four exemplary receiver threshold curves 520, 620, 720, and 721 tailored for various different target surface and obstruction conditions that may be stored in the memory 82 of the sensor system 10 (stored curves 83 in FIG. 2) and which can thus be selected by a user or by an external control system 60 in accordance with the disclosure. Moreover, as described above, the user can selectively modify the stored curves 83, and/or may generate and download customized curves 83 to the system 10. As shown in FIG. 8, moreover, one or more of the curves 83 may be wholly or partially non-linear, with the graph 800 illustrates another possible set of four receiver threshold curves 810, 820, 830, and 840 that have non-linear shapes adapted for different target surface and obstruction conditions in accordance with the disclosure.

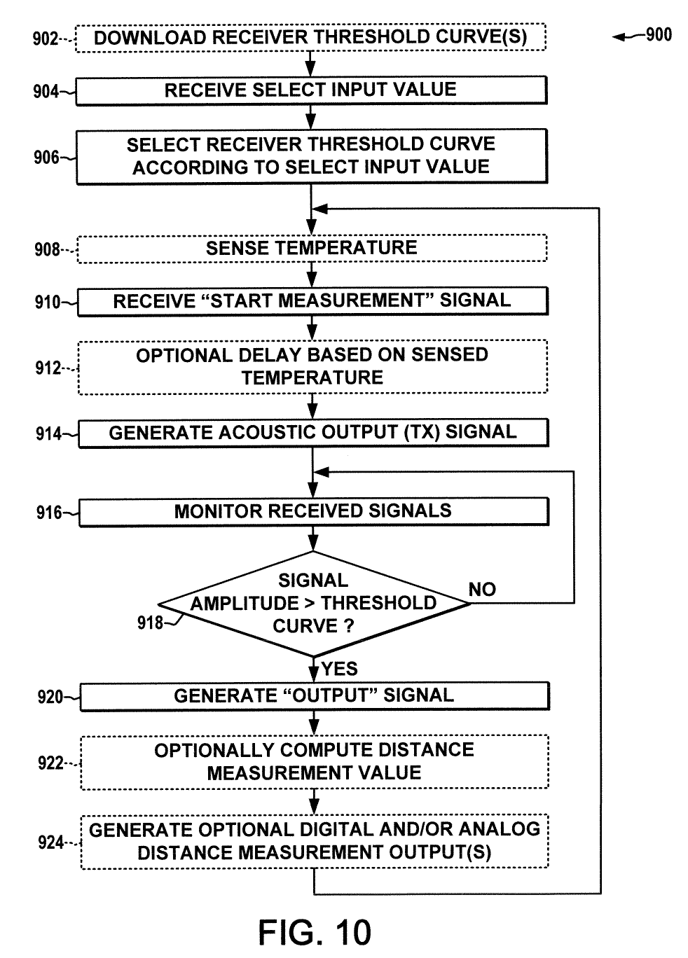

Referring now to FIG. 10, further aspects of the disclosure provide methods for measuring distance in an ultrasonic sensor system, one of which is shown as method 900 in the figure. Although the method 900 and other methods of the disclosure are illustrated and described herein as a series of acts or events, it will be appreciated that the various methods of the disclosure are not limited by the illustrated ordering of such acts or events. In this regard, some acts or events may occur in different orders and/or concurrently with other acts or events apart from those illustrated and described herein, in accordance with the disclosure. It is further noted that not all illustrated steps may be required to implement a process in accordance with the present disclosure. The methods of the disclosure, moreover, may be implemented in association with the illustrated ultrasonic sensor systems 10, 10a described above as well as with other apparatus not illustrated or described wherein all such alternatives are contemplated as falling within the scope of the disclosure and the appended claims. As an example, the method 900 of FIG. 10 may be implemented in the systems 10 and 10a above for sensing target distances or in other systems not illustrated or described herein.

The method 900 begins in FIG. 10 at 902 with an optional downloading of one or more receiver threshold curves 83, and receipt at 904 of a select input value 64 identifying one of a plurality of receiver threshold curves 83. For example, in the above system 10, the method 900 may include receiving one or more receiver threshold curves 83 at 902 from an external device 60, 96, 98. At 906, one of a plurality of curves 83 is then selected based on the select input value. At 908, the ambient temperature may optionally be sensed, and at 908 a START MEASUREMENT signal is received. If the optional thermal compensation is enabled, an optional temperature-related delay may be introduced at 912, and thereafter an acoustic output signal is generated and transmitted toward the target at 914. For the optional temperature compensation, the speed of sound in air increases with increasing temperature, absent countermeasures echoes occur earlier and grounds seems closer than is actually the case when operating at elevated temperatures. In order to compensate for this, the method 900 contemplates waiting a delay time before outputting the acoustic signal at 914, where the delay may be based on the measured temperature. Alternatively, a fixed delay may be used at 912 which allows temporal adjustment (earlier or later) of the provision of the subsequent OUTPUT signal such that the time difference between the received START MEASUREMENT signal at 910 and subsequent generation of an OUTPUT signal will be indicative of the measured target distance compensated for the measured ambient temperature.

After the acoustic output signal is directed toward the target at 914, received signals are monitored at 916 and compared with the selected threshold curve 83 at 918. This monitoring continues at 916 and 918 while the received signal is less than or equal to the time-varying value of the selected curve 83 until such time as the received signal amplitude exceeds the threshold curve (YES at 918). An OUTPUT signal is then generated at 920 (including any delay or adjustment required if the optional temperature compensation is used). At 922, in another mode of operation, the method may further include optionally computing a distance measurement value based on the time between the start of the acoustic output signal and the time when the received signal exceeds the receiver threshold curve 83, and providing a distance measurement output at 924 (e.g., analog or digital output value or signal 68) indicative of the distance measurement value. This computation may also include adjustment based on an optional ambient temperature measurement at 908 above. In various embodiments, the method may further include allowing an external device 60, 96, 98 to modify one or more receiver threshold curves 83 stored in the system 10. The method in further aspects of the disclosure may also include driving an ultrasonic receiver 30 for self cleaning in a dual transducer implementation such as that shown above in FIG. 1A. For example, the processing system 40 may be adapted to selectively drive or actuate the receiver 30 in FIG. 1A using appropriate switchable drive circuitry (not shown) during times when the receiver 30 is not being employed to listen for received acoustic signals, such as on power up or other times of non-use. In this manner, debris or other material that may have collected on the receiving surface 34 or elsewhere on the receiver 30 may be dislodged, thereby self-cleaning the receiver 30 to maintain system performance in agricultural or other adverse environments.

The above implementations are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

Having thus described the invention, the following is claimed:

1. An ultrasonic sensor system for sensing a distance between the system and a target, the sensor system comprising:
an ultrasonic transceiver system operative to direct an acoustic output signal in a first direction toward a surface of the target and to generate a received signal based on an acoustic input signal received from the first direction;
a processing system operatively coupled with the transceiver to initiate the acoustic output signal and to generate a measurement output signal when the received signal is greater than a receiver threshold curve, the processing system comprising:
a memory storing a plurality of receiver threshold curves, and
a curve selection component operative to select one of the receiver threshold curves based on a select input value.

2. The system of claim 1, wherein the transceiver system comprises:
an ultrasonic transmitter operative to direct the acoustic output signal from a transmit face in the first direction toward a surface of the target in response to a first signal; and
an ultrasonic receiver with a sensing face and operative to receive acoustic input signals reflected off the target and any intervening obstructions and to generate the received signal based on the acoustic input signals received from the first direction.

3. The system of claim 2, wherein the transmit face of the transmitter is generally perpendicular to the first direction, wherein the sensing face of the receiver faces a second direction, wherein the first and second directions are offset from one another by a sensing angle, and wherein the sensing angle is about 5 degrees or more and about 45 degrees or less.

4. The system of claim 2, wherein the sensing angle is about 5 degrees or more and about 15 degrees or less.

5. The system of claim 2, wherein the ultrasonic receiver is located a spacing distance farther from the target than is the transmitter, and wherein the spacing distance is about 0.125 inches or more and about 1.00 inches or less.

6. The system of claim 2, wherein the ultrasonic transmitter and the ultrasonic receiver are laterally spaced from one another by a distance of about 2 inches or more and about 5 inches or less along a direction generally perpendicular to the first direction.

7. The system of claim 1, wherein the transceiver system comprises an ultrasonic transceiver operative to direct an acoustic output signal from a transmit face toward the surface of the target and to generate the received signal based on the acoustic input signal.

8. The system of claim 1, further comprising a thermal sensor operative to sense an ambient temperature and to provide a temperature signal indicative of the ambient temperature; wherein the processing system comprises a temperature compensation component operative to adjust the timing of at least one of the acoustic output signal and the measurement output signal based on the temperature signal.

9. The system of claim 8, wherein the processing system computes a distance measurement value based on the time between the start of the acoustic output signal and the time when the received signal is greater than the receiver threshold curve; wherein the temperature compensation component selectively adjusts the distance measurement value based on the temperature signal; and wherein the system provides a distance measurement output indicative of the adjusted distance measurement value.

10. The system of claim 1, wherein the processing system computes a distance measurement value based on the time between the start of the acoustic output signal and the time when the received signal is greater than the receiver threshold curve; and wherein the system provides a distance measurement output indicative of the distance measurement value.

11. The system of claim 1, further comprising a logarithmic amplifier operative to amplify the received signal from the transceiver system non-linearly and to provide an amplified signal to the processing system for comparison with the receiver threshold curve.

12. The system of claim 1, wherein at least some of the receiver threshold curves are tailored for different target conditions.

13. The system of claim 1, wherein at least one of the receiver threshold curves has a negative slope.

14. The system of claim 1, wherein at least one of the receiver threshold curves is non-linear.

15. The system of claim 1, wherein at least some of the receiver threshold curves are tailored for different obstruction conditions.

16. The system of claim 1, wherein the processing system comprises a communications interface operative to receive one or more receiver threshold curves from an external device or to allow the external device to modify one or more receiver threshold curves stored in the system.

17. A method for measuring distance in an ultrasonic sensor system, the method comprising:
receiving a select input value identifying one of a plurality of receiver threshold curves;
selecting an identified one of the curves according to the select input value;
directing an acoustic output signal in a first direction toward a target;
sensing an acoustic input signal received from the first direction to generate a received signal;
comparing an amplitude of the received signal to a selected one of the receiver threshold curves; and
generating a measurement output signal when the received signal is greater than the selected receiver threshold curve.

18. The method of claim 17, further comprising receiving one or more receiver threshold curves from an external device.

19. The method of claim 17, further comprising allowing an external device to modify one or more receiver threshold curves stored in the system.

20. The method of claim 17, further comprising:
sensing an ambient temperature; and
adjusting the timing of at least one of the acoustic output signal and the measurement output signal based on the temperature signal.

21. The method of claim 17, further comprising:
sensing an ambient temperature;
computing a distance measurement value based on the time between the start of the acoustic output signal and the time when the received signal is greater than the receiver threshold curve;
selectively adjusting the distance measurement value based on the temperature signal; and
providing a distance measurement output indicative of the adjusted distance measurement value.

22. The method of claim 17, further comprising:
computing a distance measurement value based on the time between the start of the acoustic output signal and the time when the received signal is greater than the receiver threshold curve; and
providing a distance measurement output indicative of the distance measurement value.

23. The method of claim 17, further comprising driving an ultrasonic receiver to clean the receiver during a period when the receiver is not being used to sense acoustic input signals received from the first direction.
